(19) United States
(12) Patent Application Publication
(10) Pub. No.: US 2015/0312337 A1
(43) Pub. Date: Oct. 29, 2015

(54) MIRRORING LOG DATA

(71) Applicant: NetApp Inc., Sunnyvale, CA (US)

(72) Inventors: Hrishikesh Keremane, Bangalore (IN); Vaiapuri Ramasubramaniam, Bangalore (IN); Rishabh Mittal, New Delhi (IN); Harihara Kadayam, Fremont, CA (US); Tabriz Holtz, Los Gatos, CA (US); Afshin Salek Ardakani, Sunnyvale, CA (US)

(73) Assignee: NetApp Inc., Sunnyvale, CA (US)

(21) Appl. No.: 14/261,603

(22) Filed: Apr. 25, 2014

(51) Int. Cl. H04L 29/08; G06F 3/06

(52) U.S. Cl. CPC H04L 67/1095; H04L 67/2842; G06F 3/0619; G06F 3/065; G06F 3/0685

(57) ABSTRACT

One or more techniques and/or systems are provided for mirroring a caching log data structure from a primary storage controller to a secondary storage controller over multiple interconnect paths. The secondary storage controller may be configured as a backup or failover storage controller for the primary storage controller in the event the primary storage controller fails. Data and/or metadata describing the data may be mirrored from the primary storage controller to the secondary storage controller over one or more interconnect paths. The caching log data structure may be parsed into a plurality of streams. The streams may be assigned to interconnect paths between the primary storage controller and the secondary storage controller. A data ordering rule is enforced during mirroring of storage information of the streams across the interconnect paths (e.g., the secondary storage controller is to receive data in the order it was sent by respective streams).

### BACKGROUND

A network storage environment may comprise one or more storage controllers configured to provide client devices with access to data stored on storage devices accessible via the respective storage controllers. In particular, a client device may connect to a primary storage controller that may provide the client device with I/O access to a storage device accessible to and/or managed by the primary storage controller. In an example, the primary storage controller and a secondary storage controller may be configured according to a high availability configuration where the secondary storage controller is available to take over for the primary storage controller in the event a failure occurs with the primary storage controller. In another example, the secondary storage controller may be configured as a disaster recovery storage controller for the primary storage controller, where the primary storage controller and the secondary storage controller are located in different physical data sites (e.g., a first building and a second building). The secondary storage controller may be provided with access to storage devices managed by the primary storage controller. Because the primary storage controller may utilize a primary write cache (e.g., NVram comprises data and/or metadata tracked and organized by an NVlog) for expediting client I/O requests without accessing relatively slower storage devices, a synchronization technique, such as a mirroring technique, may be performed between the primary write cache of the primary storage controller and a secondary write cache of the secondary storage controller. In this way, the secondary storage controller has access to cached data and/or metadata of the primary storage controller (e.g., data not yet flushed to storage devices) in the event the secondary storage controller has to take over for the primary storage controller.

### DESCRIPTION OF THE DRAWINGS

FIG. 1 is a component block diagram illustrating an example clustered network in accordance with one or more of the provisions set forth herein.

FIG. 2 is a component block diagram illustrating an example data storage system in accordance with one or more of the provisions set forth herein.

FIG. 3 is a flow chart illustrating an exemplary method of mirroring a caching log data structure of a primary storage controller to a secondary storage controller over multiple interconnect paths.

FIG. 4 is an example of a primary storage controller and a secondary storage controller.

FIG. 5 is a component block diagram illustrating an exemplary system for mirroring a caching log data structure of a primary storage controller to a secondary storage controller over multiple interconnect paths.

FIG. 6 is an example of assigning a first stream and a second stream to a first interconnect path and a third stream to a second interconnect path.

FIG. 7 is an example of enforcing a data ordering rule for a first interconnect path.

FIG. 8 is an example of enforcing a data ordering rule for a second interconnect path.

FIG. 9 is an example of remapping a set of streams.

FIG. 10 is an example of a computer readable medium in accordance with one or more of the provisions set forth herein.

### DETAILED DESCRIPTION

Some examples of the claimed subject matter are now described with reference to the drawings, where like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. Nothing in this detailed description is admitted as prior art.

One or more systems and/or techniques for mirroring a caching log data structure from a primary storage controller to a secondary storage controller over multiple interconnect paths are provided. For example, a first interconnect path, a second interconnect path, and/or other interconnect paths may connect the primary storage controller to the secondary storage controller. A synchronization technique may mirror data and/or metadata, such as utilizing remote direct memory access (RDMA), from a primary write cache (e.g., a primary NVram) of the primary storage controller to a secondary write cache (e.g., a secondary NVram) of the secondary storage controller so that the secondary storage controller has up-to-date data and/or metadata used by the primary storage controller for write caching (e.g., in the event the secondary storage controller is to take over for the primary storage controller due to a failure of the primary storage controller). The synchronization technique follows a data ordering rule where data is to be received by the secondary storage controller in the order that the data was sent by the primary storage controller, and that data is to be sent before metadata describing such data.

As provided herein, load balancing may be provided for the interconnect paths while satisfying the data ordering rule. For example, the caching log data structure (e.g., an NVlog describing data and/or metadata stored within the primary NVram) of the primary storage controller may be parsed into a first stream, a second stream, and/or other streams. Such streams may be assigned to interconnect paths, such that a stream is merely assigned to a single interconnect path and the stream is not dependent upon another stream (e.g., an order with which the first stream sends data is unaffected by an order with which the second stream sends data, and thus the first stream and the second stream may send intermingled data across an interconnect path so long as the first stream follows a first stream data sending order and the second stream follows a second stream data sending order). The data ordering rule is enforced during mirroring of storage information of the streams from the primary write cache to the secondary write cache over the interconnect paths. Streams may be remapped amongst the interconnect paths based upon various load balancing criteria (e.g., a size of I/O transferred across an interconnect path; a number of streams assigned to an interconnect path; etc.).

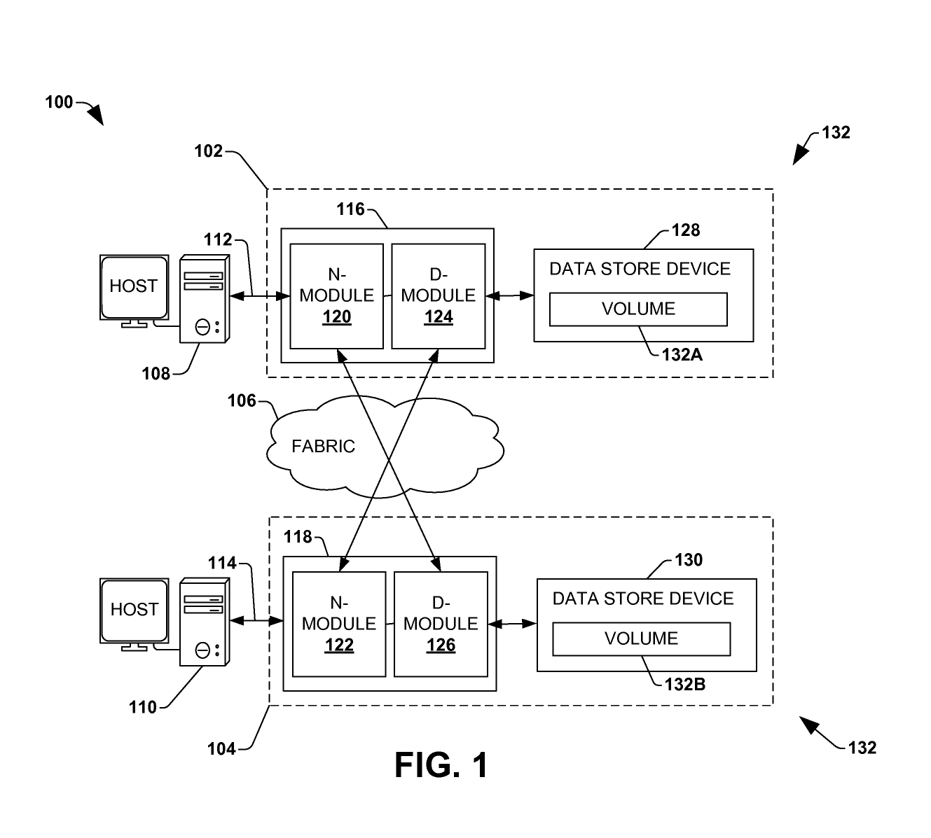

To provide context for mirroring a caching log data structure from a primary storage controller to a secondary storage controller over multiple interconnect paths, FIG. 1 illustrates an embodiment of a clustered network environment 100. It may be appreciated, however, that the techniques, etc. described herein may be implemented within the clustered network environment 100, a non-cluster network environment, and/or a variety of other computing environments, such as a desktop computing environment. That is, the instant disclosure, including the scope of the appended claims, is not meant to be limited to the examples provided herein. It will be appreciated that where the same or similar components, elements, features, items, modules, etc. are illustrated in later figures but were previously discussed with regard to prior figures, that a similar (e.g., redundant) discussion of the same may be omitted when describing the subsequent figures (e.g., for purposes of simplicity and ease of understanding).

FIG. 1 is a block diagram illustrating an example clustered network environment 100 that may implement at least some embodiments of the techniques and/or systems described herein. The example environment 100 comprises data storage systems 102 and 104 that are coupled over a cluster fabric 106, such as a computing network embodied as a private Infiniband or Fibre Channel (FC) network facilitating communication between the storage systems 102 and 104 (and one or more modules, component, etc. therein, such as, nodes 116 and 118, for example). It will be appreciated that while two data storage systems 102 and 104 and two nodes 116 and 118 are illustrated in FIG. 1, that any suitable number of such components is contemplated. In an example, nodes 116, 118 may comprise storage controllers (e.g., node 116 may comprise a primary storage controller and node 118 may comprise a secondary storage controller) that provide client devices, such as host devices 108, 110, with access to data stored within data storage devices 128, 130. Similarly, unless specifically provided otherwise herein, the same is true for other modules, elements, features, items, etc. referenced herein and/or illustrated in the accompanying drawings. That is, a particular number of components, modules, elements, features, items, etc. disclosed herein is not meant to be interpreted in a limiting manner.

It will be further appreciated that clustered networks are not limited to any particular geographic areas and can be clustered locally and/or remotely. Thus, in one embodiment a clustered network can be distributed over a plurality of storage systems and/or nodes located in a plurality of geographic locations; while in another embodiment a clustered network can include data storage systems (e.g., 102, 104) residing in a same geographic location (e.g., in a single onsite rack of data storage devices).

In the illustrated example, one or more host devices 108, 110 which may comprise, for example, client devices, personal computers (PCs), computing devices used for storage (e.g., storage servers), and other computers or peripheral devices (e.g., printers), are coupled to the respective data storage systems 102, 104 by storage network connections 112, 114. Network connection may comprise a local area network (LAN) or wide area network (WAN), for example, that utilizes Network Attached Storage (NAS) protocols, such as a Common Internet File System (CIFS) protocol or a Network File System (NFS) protocol to exchange data packets. Illustratively, the host devices 108, 110 may be general-purpose computers running applications, and may interact with the data storage systems 102, 104 using a client/server model for exchange of information. That is, the host device may request data from the data storage system (e.g., data on a storage device managed by a network storage control configured to process I/O commands issued by the host device for the storage device), and the data storage system may return results of the request to the host device via one or more network connections 112, 114.

The nodes 116, 118 on clustered data storage systems 102, 104 can comprise network or host nodes that are interconnected as a cluster to provide data storage and management services, such as to an enterprise having remote locations, for example. Such a node in a data storage and management network cluster environment 100 can be a device attached to the network as a connection point, redistribution point or communication endpoint, for example. A node may be capable of sending, receiving, and/or forwarding information over a network communications channel, and could comprise any device that meets any or all of these criteria. One example of a node may be a data storage and management server attached to a network, where the server can comprise a general purpose computer or a computing device particularly configured to operate as a server in a data storage and management system.

As illustrated in the exemplary environment 100, nodes 116, 118 can comprise various functional components that coordinate to provide distributed storage architecture for the cluster. For example, the nodes can comprise a network module 120, 122 (e.g., N-Module, or N-Blade) and a data module 124, 126 (e.g., D-Module, or D-Blade). Network modules 120, 122 can be configured to allow the nodes 116, 118 (e.g., network storage controllers) to connect with host devices 108, 110 over the network connections 112, 114, for example, allowing the host devices 108, 110 to access data stored in the distributed storage system. Further, the network modules 120, 122 can provide connections with one or more other components through the cluster fabric 106. For example, in FIG. 1, a first network module 120 of first node 116 can access a second data storage device 130 by sending a request through a second data module 126 of a second node 118.

Data modules 124, 126 can be configured to connect one or more data storage devices 128, 130, such as disks or arrays of disks, flash memory, or some other form of data storage, to the nodes 116, 118. The nodes 116, 118 can be interconnected by the cluster fabric 106, for example, allowing respective nodes in the cluster to access data on data storage devices 128, 130 connected to different nodes in the cluster. Often, data modules 124, 126 communicate with the data storage devices 128, 130 according to a storage area network (SAN) protocol, such as Small Computer System Interface (SCSI) or Fiber Channel Protocol (FCP), for example. Thus, as seen from an operating system on a node 116, 118, the data storage devices 128, 130 can appear as locally attached to the operating system. In this manner, different nodes 116, 118, etc. may access data blocks through the operating system, rather than expressly requesting abstract files.

It should be appreciated that, while the example embodiment 100 illustrates an equal number of N and D modules, other embodiments may comprise a differing number of these modules. For example, there may be a plurality of N and/or D modules interconnected in a cluster that does not have a one-to-one correspondence between the N and D modules. That is, different nodes can have a different number of N and D modules, and the same node can have a different number of N modules than D modules.

Further, a host device 108, 110 can be networked with the nodes 116, 118 in the cluster, over the networking connections 112, 114. As an example, respective host devices 108, 110 that are networked to a cluster may request services (e.g., exchanging of information in the form of data packets) of a node 116, 118 in the cluster, and the node 116, 118 can return results of the requested services to the host devices 108, 110. In one embodiment, the host devices 108, 110 can exchange information with the network modules 120, 122 residing in the nodes (e.g., network hosts) 116, 118 in the data storage systems 102, 104.

In one embodiment, the data storage devices 128, 130 comprise volumes 132, which is an implementation of storage of information onto disk drives or disk arrays or other storage (e.g., flash) as a file-system for data, for example. Volumes can span a portion of a disk, a collection of disks, or portions of disks, for example, and typically define an overall logical arrangement of file storage on disk space in the storage system. In one embodiment a volume can comprise stored data as one or more files that reside in a hierarchical directory structure within the volume.

Volumes are typically configured in formats that may be associated with particular storage systems, and respective volume formats typically comprise features that provide functionality to the volumes, such as providing an ability for volumes to form clusters. For example, where a first storage system may utilize a first format for their volumes, a second storage system may utilize a second format for their volumes.

In the example environment 100, the host devices 108, 110 can utilize the data storage systems 102, 104 to store and retrieve data from the volumes 132. In this embodiment, for example, the host device 108 can send data packets to the N-module 120 in the node 116 within data storage system 102. The node 116 can forward the data to the data storage device 128 using the D-module 124, where the data storage device 128 comprises volume 132A. In this way, in this example, the host device can access the storage volume 132A, to store and/or retrieve data, using the data storage system 102 connected by the network connection 112. Further, in this embodiment, the host device 110 can exchange data with the N-module 122 in the host 118 within the data storage system 104 (e.g., which may be remote from the data storage system 102). The host 118 can forward the data to the data storage device 130 using the D-module 126, thereby accessing volume 132B associated with the data storage device 130.

It may be appreciated that interconnect failover may be implemented within the clustered network environment 100. For example, the node 116 may comprise a primary storage controller and the node 104 may comprise a secondary storage controller. A mapping component may be implemented between the node 116 and the node 118. The mapping component may be configured to load balance streams amongst one or more interconnect paths between the node 116 and the node 118 (e.g., an interconnect path through the fabric 106). The mapping component may be implemented within the fabric 106, on the host 108, on the host 110, on the node 116, on the node 118, or between the node 116 and the node 118.

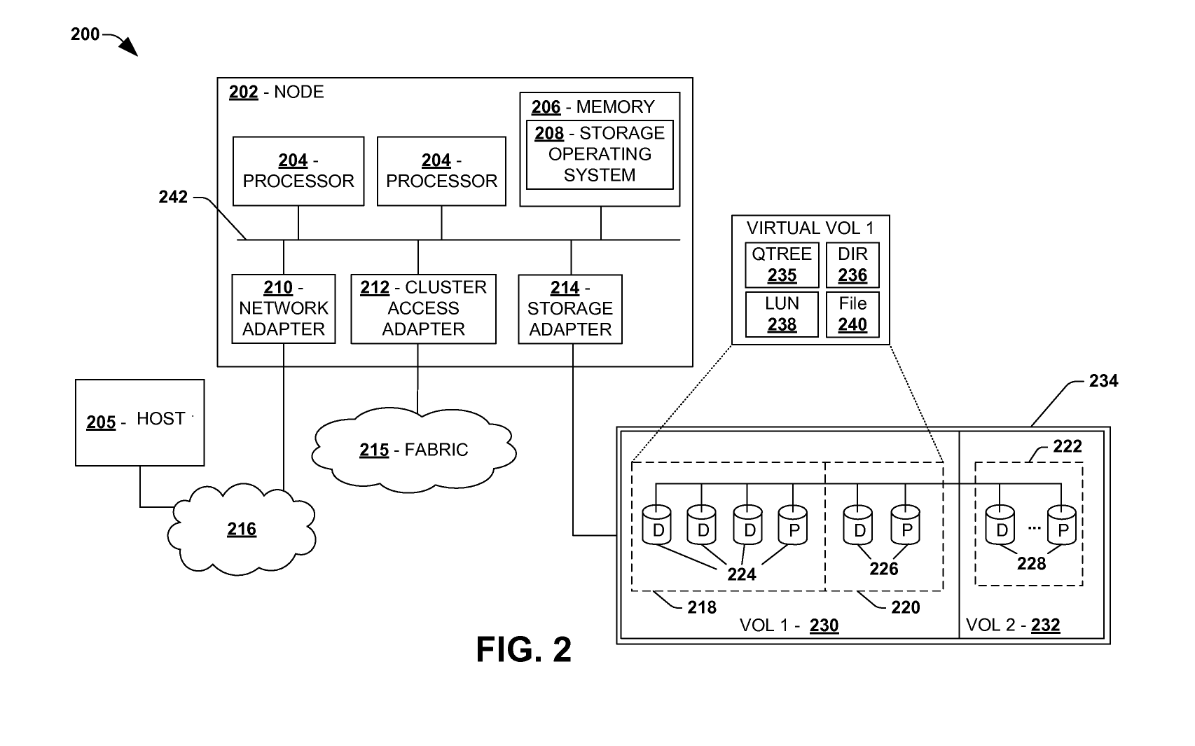

FIG. 2 is an illustrative example of a data storage system 200 (e.g., 102, 104 in FIG. 1), providing further detail of an embodiment of components that may implement one or more of the techniques and/or systems described herein. The example data storage system 200 comprises a node 202 (e.g., host nodes 116, 118 in FIG. 1), and a data storage device 234 (e.g., data storage devices 128, 130 in FIG. 1). The node 202 may be a general purpose computer, for example, or some other computing device particularly configured to operate as a storage server. A host device 205 (e.g., 108, 110 in FIG. 1) can be connected to the node 202 over a network 216, for example, to provides access to files and/or other data stored on the data storage device 234. In an example, the node 202 comprises a storage controller that provides client devices, such as the host device 205, with access to data stored within data storage device 234.

The data storage device 234 can comprise mass storage devices, such as disks 224, 226, 228 of a disk array 218, 220, 222. It will be appreciated that the techniques and systems, described herein, are not limited by the example embodiment. For example, disks 224, 226, 228 may comprise any type of mass storage devices, including but not limited to magnetic disk drives, flash memory, and any other similar media adapted to store information, including, for example, data (D) and/or parity (P) information.

The node 202 comprises one or more processors 204, a memory 206, a network adapter 210, a cluster access adapter 212, and a storage adapter 214 interconnected by a system bus 242. The storage system 200 also includes an operating system 208 installed in the memory 206 of the node 202 that can, for example, implement a Redundant Array of Independent (or Inexpensive) Disks (RAID) optimization technique to optimize a reconstruction process of data of a failed disk in an array.

The operating system 208 can also manage communications for the data storage system, and communications between other data storage systems that may be in a clustered network, such as attached to a cluster fabric 215 (e.g., 106 in FIG. 1). Thus, the node 202, such as a network storage controller, can respond to host device requests to manage data on the data storage device 234 (e.g., or additional clustered devices) in accordance with these host device requests. The operating system 208 can often establish one or more file systems on the data storage system 200, where a file system can include software code and data structures that implement a persistent hierarchical namespace of files and directories, for example. As an example, when a new data storage device (not shown) is added to a clustered network system, the operating system 208 is informed where, in an existing directory tree, new files associated with the new data storage device are to be stored. This is often referred to as “mounting” a file system.

In the example data storage system 200, memory 206 can include storage locations that are addressable by the processors 204 and adapters 210, 212, 214 for storing related software program code and data structures. The processors 204 and adapters 210, 212, 214 may, for example, include processing elements and/or logic circuitry configured to execute the software code and manipulate the data structures. The operating system 208, portions of which are typically resident in the memory 206 and executed by the processing elements, functionally organizes the storage system by, among other things, invoking storage operations in support of a file service implemented by the storage system. It will be apparent to those skilled in the art that other processing and memory mechanisms, including various computer readable media, may be used for storing and/or executing program instructions pertaining to the techniques described herein. For example, the operating system can also utilize one or more control files (not shown) to aid in the provisioning of virtual machines.

The network adapter 210 includes the mechanical, electrical and signaling circuitry needed to connect the data storage system 200 to a host device 205 over a computer network 216, which may comprise, among other things, a point-to-point connection or a shared medium, such as a local area network. The host device 205 (e.g., 108, 110 of FIG. 1) may be a general-purpose computer configured to execute applications. As described above, the host device 205 may interact with the data storage system 200 in accordance with a client/host model of information delivery.

The storage adapter 214 cooperates with the operating system 208 executing on the node 202 to access information requested by the host device 205 (e.g., access data on a storage device managed by a network storage controller). The information may be stored on any type of attached array of writeable media such as magnetic disk drives, flash memory, and/or any other similar media adapted to store information. In the example data storage system 200, the information can be stored in data blocks on the disks 224, 226, 228. The storage adapter 214 can include input/output (I/O) interface circuitry that couples to the disks over an I/O interconnect arrangement, such as a storage area network (SAN) protocol (e.g., Small Computer System Interface (SCSI), iSCSI, hyperSCSI, Fiber Channel Protocol (FCP)). The information is retrieved by the storage adapter 214 and, if necessary, processed by the one or more processors 204 (or the storage adapter 214 itself) prior to being forwarded over the system bus 242 to the network adapter 210 (and/or the cluster access adapter 212 if sending to another node in the cluster) where the information is formatted into a data packet and returned to the host device 205 over the network connection 216 (and/or returned to another node attached to the cluster over the cluster fabric 215).

In one embodiment, storage of information on arrays 218, 220, 222 can be implemented as one or more storage “volumes” 230, 232 that are comprised of a cluster of disks 224, 226, 228 defining an overall logical arrangement of disk space. The disks 224, 226, 228 that comprise one or more volumes are typically organized as one or more groups of RAIDs. As an example, volume 230 comprises an aggregate of disk arrays 218 and 220, which comprise the cluster of disks 224 and 226.

In one embodiment, to facilitate access to disks 224, 226, 228, the operating system 208 may implement a file system (e.g., write anywhere file system) that logically organizes the information as a hierarchical structure of directories and files on the disks. In this embodiment, respective files may be implemented as a set of disk blocks configured to store information, whereas directories may be implemented as specially formatted files in which information about other files and directories are stored.

Whatever the underlying physical configuration within this data storage system 200, data can be stored as files within physical and/or virtual volumes, which can be associated with respective volume identifiers, such as file system identifiers (FSIDs), which can be 32-bits in length in one example.

A physical volume, which may also be referred to as a “traditional volume” in some contexts, corresponds to at least a portion of physical storage devices whose address, addressable space, location, etc. doesn't change, such as at least some of one or more data storage devices 234 (e.g., a Redundant Array of Independent (or Inexpensive) Disks (RAID system)). Typically the location of the physical volume doesn't change in that the (range of) address(es) used to access it generally remains constant.

A virtual volume, in contrast, is stored over an aggregate of disparate portions of different physical storage devices. The virtual volume may be a collection of different available portions of different physical storage device locations, such as some available space from each of the disks 224, 226, and/or 228. It will be appreciated that since a virtual volume is not “tied” to any one particular storage device, a virtual volume can be said to include a layer of abstraction or virtualization, which allows it to be resized and/or flexible in some regards.

Further, a virtual volume can include one or more logical unit numbers (LUNs) 238, directories 236, qtrees 235, and files 240. Among other things, these features, but more particularly LUNS, allow the disparate memory locations within which data is stored to be identified, for example, and grouped as data storage unit. As such, the LUNs 238 may be characterized as constituting a virtual disk or drive upon which data within the virtual volume is stored within the aggregate. For example, LUNs are often referred to as virtual drives, such that they emulate a hard drive from a general purpose computer, while they actually comprise data blocks stored in various parts of a volume.

In one embodiment, one or more data storage devices 234 can have one or more physical ports, wherein each physical port can be assigned a target address (e.g., SCSI target address). To represent respective volumes stored on a data storage device, a target address on the data storage device can be used to identify one or more LUNs 238. Thus, for example, when the node 202 connects to a volume 230, 232 through the storage adapter 214, a connection between the node 202 and the one or more LUNs 238 underlying the volume is created.

In one embodiment, respective target addresses can identify multiple LUNs, such that a target address can represent multiple volumes. The I/O interface, which can be implemented as circuitry and/or software in the storage adapter 214 or as executable code residing in memory 206 and executed by the processors 204, for example, can connect to volume 230 by using one or more addresses that identify the LUNs 238.

It may be appreciated that interconnect failover may be implemented for the data storage system 200. For example, the node 202 may comprise a primary storage controller that stores data within the data storage device 234. A secondary storage controller, not illustrated, may function as a failover or disaster recovery storage controller for the node 202. A mapping component may be implemented between the node 202 and the secondary storage controller. The mapping component may be configured to perform load balancing of streams amongst one or more interconnect paths between the node 202 and the secondary storage controller (e.g., an interconnect path through the cluster fabric 215). The mapping component may be implemented within the cluster fabric 215, on the node 202, on the host 205, on the secondary storage controller, or between the node 202 and the secondary storage controller.

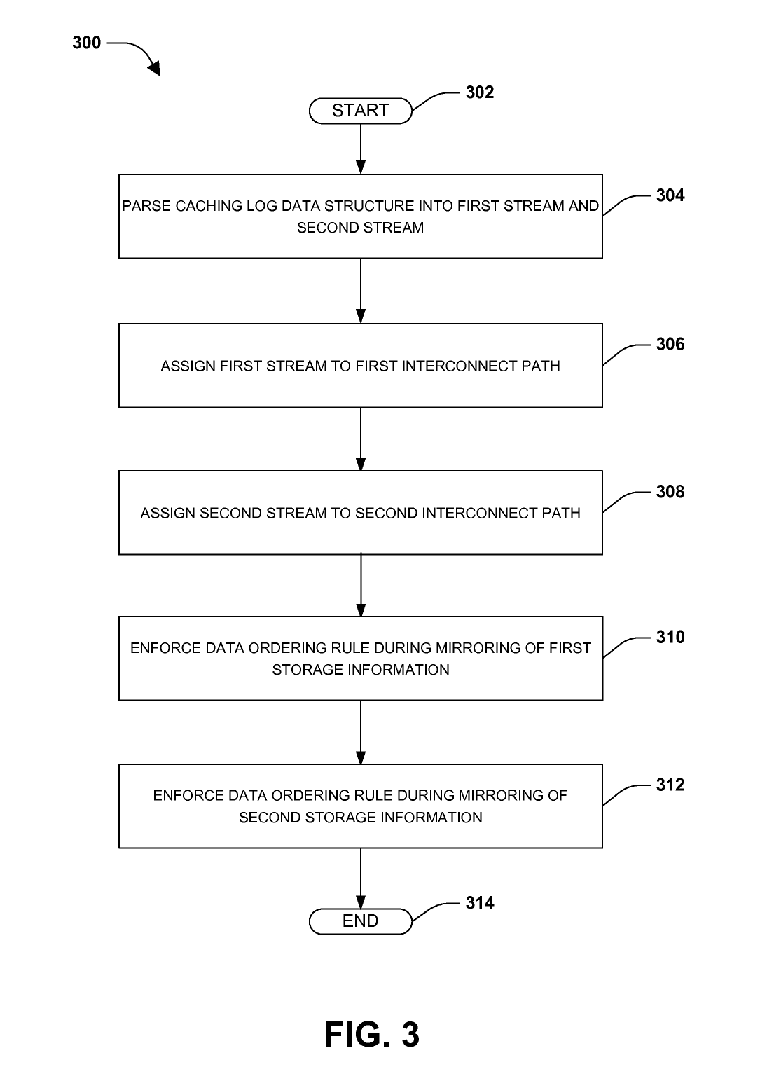

One embodiment of mirroring a caching log data structure of a primary storage controller to a secondary storage controller over multiple interconnect paths is illustrated by an exemplary method 300 of FIG. 3. At 302, the method starts. The primary storage controller may provide client devices with I/O access to data stored within one or more storage devices. To improve access response times for the client devices, the primary storage controller may maintain a primary write cache (e.g., an NVram comprises data and/or metadata tracked and organized by an NVlog). The primary storage controller may expedite I/O requests by clients utilizing data and/or metadata stored within the primary write cache, as opposed accessing one or more storage devices having a relatively higher access latency than the primary write cache.

The secondary storage controller may be configured as a failover or disaster recovery storage controller for the primary storage controller. For example, the secondary storage controller may be configured as a disaster recovery controller hosted by a first physical data site, such as a first building, that is separate from a second physical data site, such as a second building, hosting the primary storage controller. The secondary storage controller may have access to the storage devices used by the primary storage controller to persistently store data (e.g., data flushed from the primary write cache to the storage devices). A synchronization technique, such as mirroring, may be used to synchronize a secondary write cache of the secondary storage controller with the primary write cache so that the secondary storage controller has access to up-to-date mirrored copies of data and/or metadata cached by the primary storage controller within the primary write cache. Such mirroring may be performed over one or more interconnect paths between the primary storage controller and the secondary storage controller. In an example, the interconnect paths correspond to remote direct memory access (RDMA) streams/operations. The mirroring may adhere to a data ordering rule that data is to be received by the secondary storage controller in the order that the data was sent from the primary storage controller, and that data is to arrive before metadata describing such data. As provided herein, mirroring may be performed over multiple interconnect paths (e.g., for load balancing and/or concurrent data transfer) while adhering to the data ordering rule.

At 304, a caching log data structure of the primary storage controller (e.g., a serialized log, such as the NVlog, that tracks, organizes, and/or validates data and/or metadata cached within the primary NVram) may be parsed into a plurality of streams, such as a first stream, a second stream, a third stream and/or other streams. In an example, the caching log data structure may be parsed based upon a variety of parsing criteria (e.g., client ownership of data; a storage aggregate with which the data is associated; a threshold amount of data, such as 4 MB or any dynamically configurable size, may be parsed into the first stream, and then a second stream is created for the next threshold amount of data; etc.). Data and/or metadata within a stream may be treated as a single logical unit of mirroring workflow, such that data within the stream is to arrive at the secondary storage controller before metadata of the stream (e.g., metadata specifying a current count of the data), that the data will be received by the secondary storage controller in the order that the data is sent, and that the stream does not have a dependency or relationship upon another stream (e.g., a first data sending order of the first stream does not depend upon a second data sending order of the second stream). In an example, streams may be created at boot time or may be dynamically created such as during operation of the primary storage controller.

In an example, a stream is assigned to merely a single interconnect path, and an interconnect path may have one or more streams assigned to the interconnect path. At 306, the first stream is assigned to a first interconnect path between the primary storage controller and the secondary storage controller. The first stream may be limited to utilizing the first interconnect path but no other interconnect paths while the first stream is assigned to the first interconnect path. At 308, the second stream is assigned to a second interconnect path between the primary storage controller and the secondary storage controller. The second stream may be limited to utilizing the second interconnect path but no other interconnect paths while the second stream is assigned to the second interconnect path. In this way, the plurality of streams are assigned to interconnect paths between the primary storage controller and the secondary storage controller (e.g., the third stream may be assigned to the first interconnect path).

At 310, a data ordering rule may be enforced during mirroring of first storage information of the first stream (e.g., data and/or metadata parsed into the first stream) from the primary write cache of the primary storage controller to the secondary write cache of the secondary storage controller over the first interconnect path. At 312, the data ordering rule may be enforced during mirroring of second storage information of the second stream (e.g., data and/or metadata parsed into the second stream) from the primary write cache of the primary storage controller to the secondary write cache of the secondary storage controller over the second interconnect path. The data ordering rule may specify that data of a stream is to be sent according to a data sending order such that the secondary storage controller receives the data according to the data sending order. For example, if the first stream sends data (A) first, data (B) second, and data (C) third over the first interconnect path, then the secondary storage controller is to receive the data (A) first, the data (B) second, and the data (C) third so that ordering is maintained between the primary write cache and the secondary write cache. The data ordering rule may specify that data is to be sent before metadata describing the data (e.g., if metadata, indicating that data (C) is available, is received before the data (C) is received by the secondary storage controller, then an error may occur because the secondary storage controller may determine that data (C) is available before data (C) is actually available). Because streams may be assigned to single interconnect paths and the data ordering rule is enforced, mirroring of the first storage information of the first stream, the second storage information of the second stream, and/or other storage information of other streams may be concurrently performed. Because multiple streams are used to mirror data and/or metadata from the primary storage controller to the secondary storage controller, a secondary caching log data structure and/or a mirroring layer associated with the secondary storage controller may be configured to reassemble the mirrored data and/or the mirrored metadata into the secondary write cache.

Load balancing may be performed amongst the streams to remap streams to interconnect paths based upon various remapping criteria. Streams may be dynamically remapped based upon various triggers. In an example, a client remapping trigger may be received from a client device (e.g., a user of the NVlog mirroring, such as an application or an operating system, may indicate that there will be no pending I/O operations for a stream and thus it may be safe to remap the stream to an alternative interconnect path). In another example, a consistency point trigger may be identified (e.g., a point at which contents of the primary NVram are flushed to a storage device based upon the NVlog).

In an example, streams are remapped based upon a round robin remapping scheme. The round robin remapping scheme may remap a stream to one or more interconnect paths so that incoming storage information of the stream may be sent across the remapped interconnect paths. Because the stream may be remapped to multiple interconnect paths, for example, metadata will be sent after data is sent so that the secondary storage controller receives the data before the metadata. In this way, round robin remapping may be used to rebalance I/O workflow. In another example, streams are remapped based upon a dynamic remapping scheme. In an example of the dynamic remapping scheme, streams are remapped based upon a load remapping criteria (e.g., a stream may be remapped to an interconnect path having a load, corresponding to a number of I/Os and sizes of such I/Os, below a utilization threshold). In another example of the dynamic remapping scheme, streams are remapped based upon a stream to path remapping criteria (e.g., a stream may be remapped to an interconnect path being mapped to a number of streams below a mapping threshold). In this way, streams are created for mirroring storage information, such as data and/or metadata, across multiple interconnect paths, and load balancing may be dynamically performed for such streams based upon various remapping criteria. At 314, the method ends.

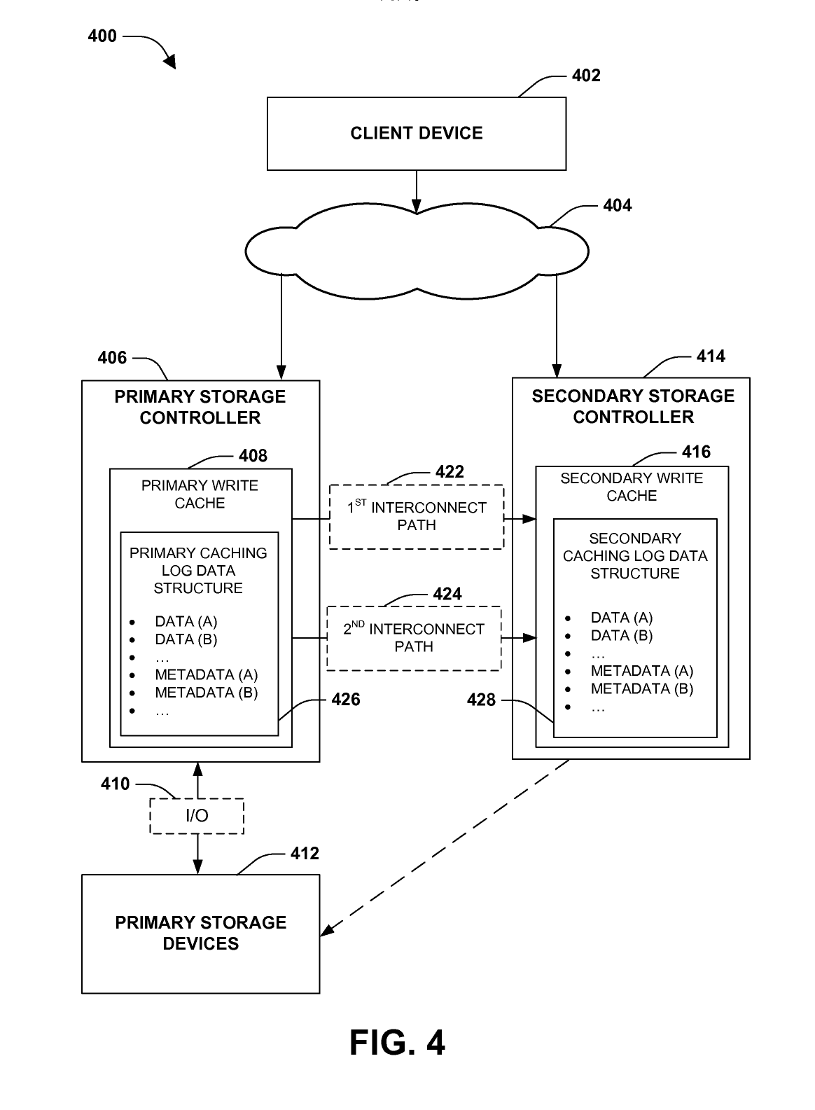

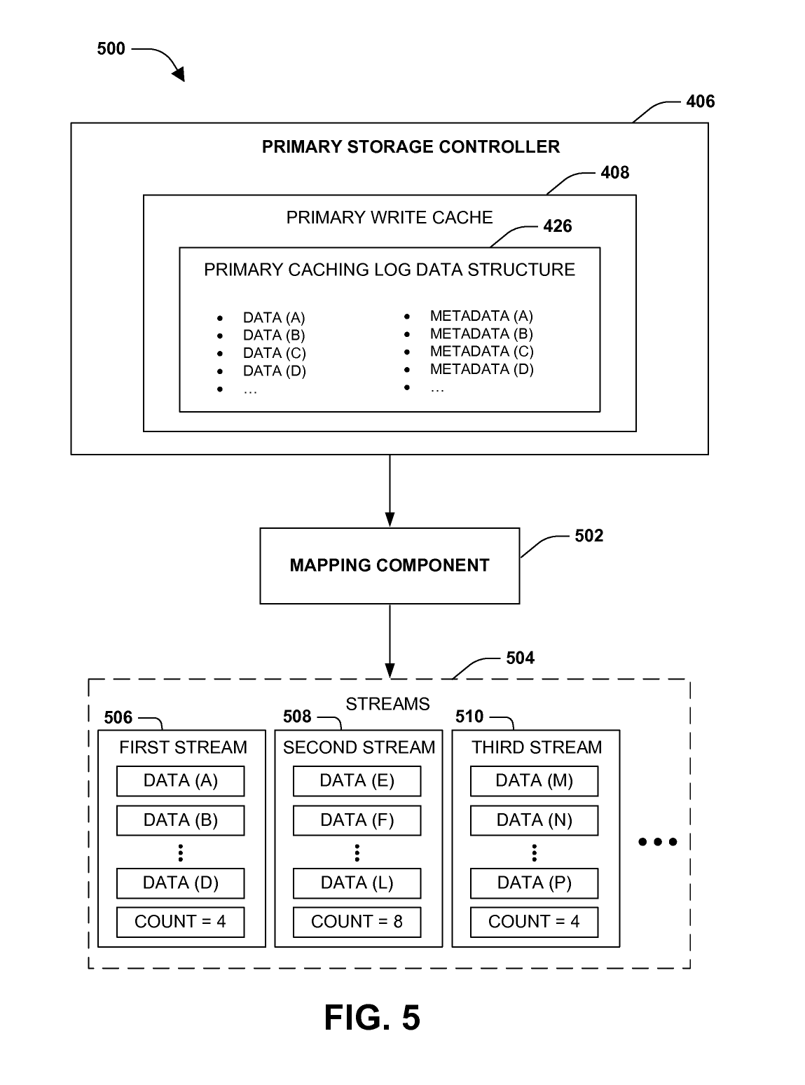

FIG. 4 illustrates an example 400 of a primary storage controller 406 and a secondary storage controller 414. A client device 402 may connect to the primary storage controller 406 and/or the secondary storage controller 414 through a network 404. The primary storage controller 406 may be configured to provide the client device 402 with I/O access 410 to primary storage devices 412 managed by the primary storage controller 406. In an example, the secondary storage controller 414 may be configured as a failover or disaster recovery storage controller for the primary storage controller 406 in the event the primary storage controller 406 fails. The secondary storage controller 414 may have access to the primary storage devices 412. The primary storage controller 406 may utilize a primary write cache 408 (e.g., an NVram) to store data and/or metadata managed by a primary caching log data structure 426 (e.g., an NVlog). A synchronization technique (e.g., a mirroring technique) may mirror the data and/or metadata from the primary write cache 408 to a secondary write cache 416 of the secondary storage controller 414. A secondary caching log data structure 428 may manage the mirrored data and/or the mirrored metadata within the secondary write cache 416. Data and/or metadata that is to be mirrored may be partitioned or grouped into streams corresponding to logical units of storage information (e.g., FIG. 5). For example, a first stream, a second stream, and/or other streams may send I/O (e.g., storage information such as data and/or metadata for mirroring between the primary write cache 408 and the secondary write cache 416) over the first interconnect path 422 to the secondary write cache 416. A third stream and/or other streams may send I/O (e.g., storage information such as data and/or metadata for mirroring between the primary write cache 408 and the secondary write cache 416) over the second interconnect path 424 to the secondary write cache 416. It may be appreciated that other interconnect paths may be formed between the primary storage controller 406 and the secondary storage controller 414.

FIG. 5 illustrates an example of a system 500 for mirroring the primary caching log data structure 426 from the primary storage controller 406 to the secondary storage controller 414 over multiple interconnect paths (e.g., the first interconnect path 422 and the second interconnect path 424 of FIG. 4). The system 500 may comprise a mapping component 502. The mapping component 502 may be configured to parse the primary caching log data structure 426 into a set of streams 504. For example, the mapping component 502 may create a first stream 506 corresponding to data (A), data (B), data (C), data (D), and/or metadata such as a data count of 4 data entries (e.g., data (A), data (B), data (C), and data (D)). The mapping component 502 may create a second stream 508 corresponding to data (E), data (F), data (G), data (H), data (I), data (J), data (K), data (L), and/or metadata such as a data count of 8 data entries (e.g., data (E), data (F), data (G), data (H), data (I), data (J), data (K), and data (L)). The mapping component 502 may create a third stream 510 corresponding to data (M), data (N), data (0), data (P), and/or metadata such as a data count of 4 data entries (e.g., data (M), data (N), data (0), and data (P)). It may be appreciated that the mapping component 502 may create any number of streams, and that a stream may comprise any amount of data and/or metadata (e.g., a stream size may be set to 4MB, which may be dynamically adjusted based upon various performance factors, such as mirroring time between the primary storage controller 406 and the secondary storage controller 414 that may affect client request response times for client requests that are not declared complete until after data has been mirrored from the primary storage controller 406 to the secondary storage controller 414).

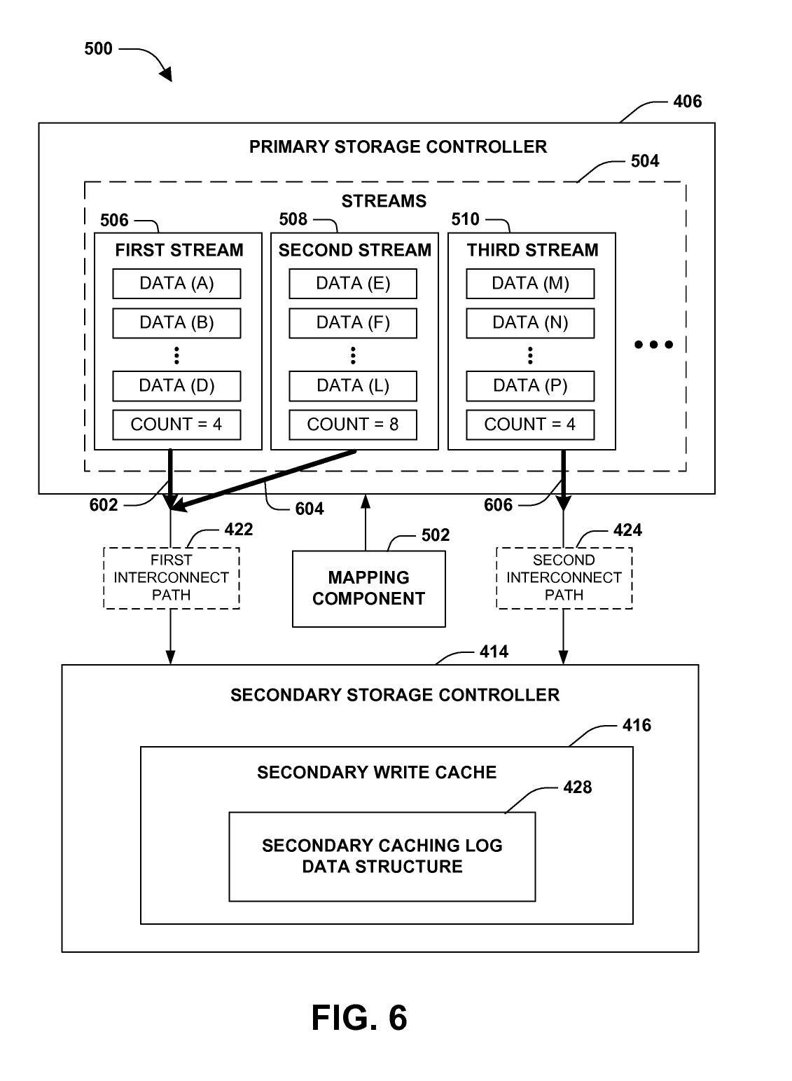

The mapping component 502 is configured to assign one or more streams to interconnect paths between the primary storage controller 406 and the secondary storage controller 414, as illustrated in FIG. 6. In an example, the mapping component 502 may perform a first assignment 602 to assign the first stream 506 to the first interconnect path 422 for mirroring of data (A), data (B), data (C), data (D), and/or metadata from the primary write cache 408 of the primary storage controller 406 to the secondary write cache 416 of the secondary storage controller 414, such as into the secondary caching log data structure 428. The mapping component 502 may perform a second assignment 604 to assign the second stream 508 to the first interconnect path 422 for mirroring of data (E), data (F), data (G), data (H), data (I), data (J), data (K), data (L), and/or metadata from the primary write cache 408 of the primary storage controller 406 to the secondary write cache 416 of the secondary storage controller 414, such as into the secondary caching log data structure 428. The mapping component 502 may perform a third assignment 606 to assign the third stream 510 to the second interconnect path 424 for mirroring of data (M), data (N), data (0), data (P), and/or metadata from the primary write cache 408 of the primary storage controller 406 to the secondary write cache 416 of the secondary storage controller 414, such as into the secondary caching log data structure 428.

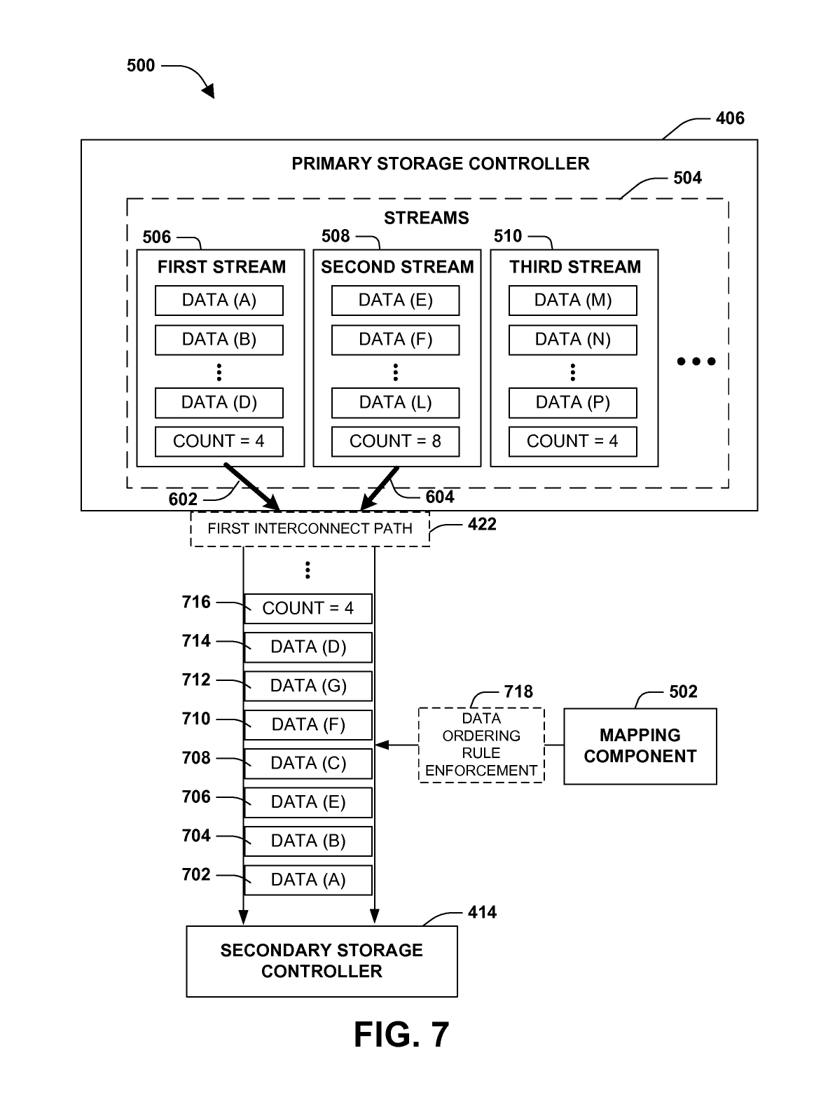

The mapping component 502 may be configure to enforce a data ordering rule 718 during mirroring of storage information, such as data and/or metadata, across the first interconnect path 422, as illustrated in FIG. 7. In an example, the data ordering rule 718 may specify that a stream can use an interconnect path to which the stream is assigned and no other interconnect path for mirroring (e.g., the first stream 506 and the second stream 508 can use the first interconnect path 422, but are restricted from using the second interconnect path 424 or other interconnect paths). In an example, the data ordering rule 718 may specify that a stream is to send data according to a data sending order such that the secondary storage controller receives the data according to the data sending order (e.g., the secondary storage controller 414 is to receive data in the order that a stream sent the data). In an example, the data ordering rule 718 may specify that data of a stream is to be received by the secondary storage controller 414 before metadata of the stream.

In an example of enforcing the data ordering rule 718, the first stream 506 sends data (A) 702 over the first interconnect path 422. The first stream 506 sends data (B) 704 over the first interconnect path 422, which satisfies the data ordering rule 718 because the secondary storage controller 414 will receive data (A) 702 before data (B) 704. The second stream 508 sends data (E) 706 over the first interconnect path 422, which satisfies the data ordering rule 718 because the first stream 506 and the second stream 508 are not interdependent (e.g., the data ordering rule 718 is satisfied where the secondary storage controller 414 receives first storage information sent by the first stream 506 in the order that the first stream 506 sent the first storage information, even if second storage information from the second stream 508 is intermingled with the first storage information because ordering of storage information of a stream is independent from storage information sent by other streams).

The first stream 506 sends the data (C) 708 over the first interconnect path 422, which satisfies the data ordering rule 718 because the secondary storage controller 414 will receive data (A) 702 first, data (B) 704 second, and data (C) 708 third from the first stream 506 over the first interconnect path 422 (e.g., and intermingling of second storage information by the second stream 508 is allowed). The second stream 508 sends the data (F) 710 over the first interconnect path 422, which satisfies the data ordering rule 718 because the secondary storage controller 414 will receive data (E) 706 first and data (F) 710 second from the second stream 508 over the first interconnect path 422 (e.g., and intermingling of first storage information by the first stream 506 is allowed). The second stream 508 sends the data (G) 712 over the first interconnect path 422, which satisfies the data ordering rule 718 because the secondary storage controller 414 will receive data (E) 706 first, data (F) 710 second, and data (G) 712 third from the second stream 508 over the first interconnect path 422 (e.g., and intermingling of first storage information by the first stream 506 is allowed).

The first stream 506 sends the data (D) 714 over the first interconnect path 422, which satisfies the data ordering rule 718 because the secondary storage controller 414 will receive data (A) 702 first, data (B) 704 second, data (C) 708 third, and data (D) 714 fourth from the first stream 505 over the first interconnect path 422 (e.g., and intermingling of second storage information by the second stream 508 is allowed). The first stream 506 sends metadata 716 over the first interconnect path 422, which satisfies the data ordering rule 718 because the metadata 716 will be received by the secondary storage controller 414 after the data of the first stream 506 (e.g., data (A) 702, data (B) 704, data (C) 708, and data (D) 714).

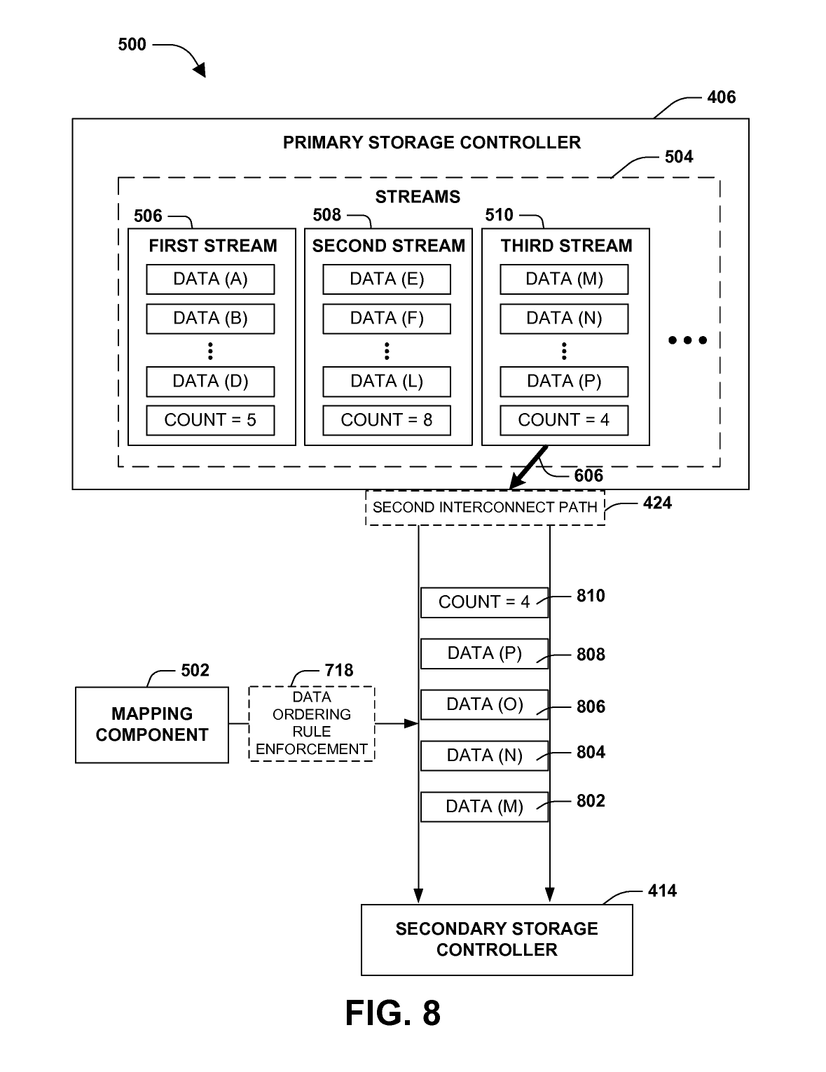

The mapping component 502 may be configured to enforce the data ordering rule 718 during mirroring of storage information (e.g., data and/or metadata) across the second interconnect path 424, as illustrated in FIG. 8. The third stream 510 sends data (M) 802 first, data (N) 804 second, data (O) 806 third, data (P) 808 fourth, and the metadata 810 over the second interconnect path 424. The data ordering rule 718 is satisfied because the secondary storage controller 414 will receive the data in the order that the third stream 510 sent the data, such as receiving data (M) 802 first, data (N) 804 second, data (O) 806 third, and data (P) 808 fourth. The data ordering rule 718 is satisfied because the secondary storage controller 414 will receive the data before the metadata 810. In an example, third storage information of the third stream 510 (data (M) 802, data (N) 804, data (O) 806, data (P) 808, metadata 810) may be mirrored across the second interconnect path 424 concurrently with the mirroring of the first storage information of the first stream 506 and/or the second storage information of the second stream 508 across the first interconnect path 424 (e.g., FIG. 7), while satisfying the data ordering rule 718.

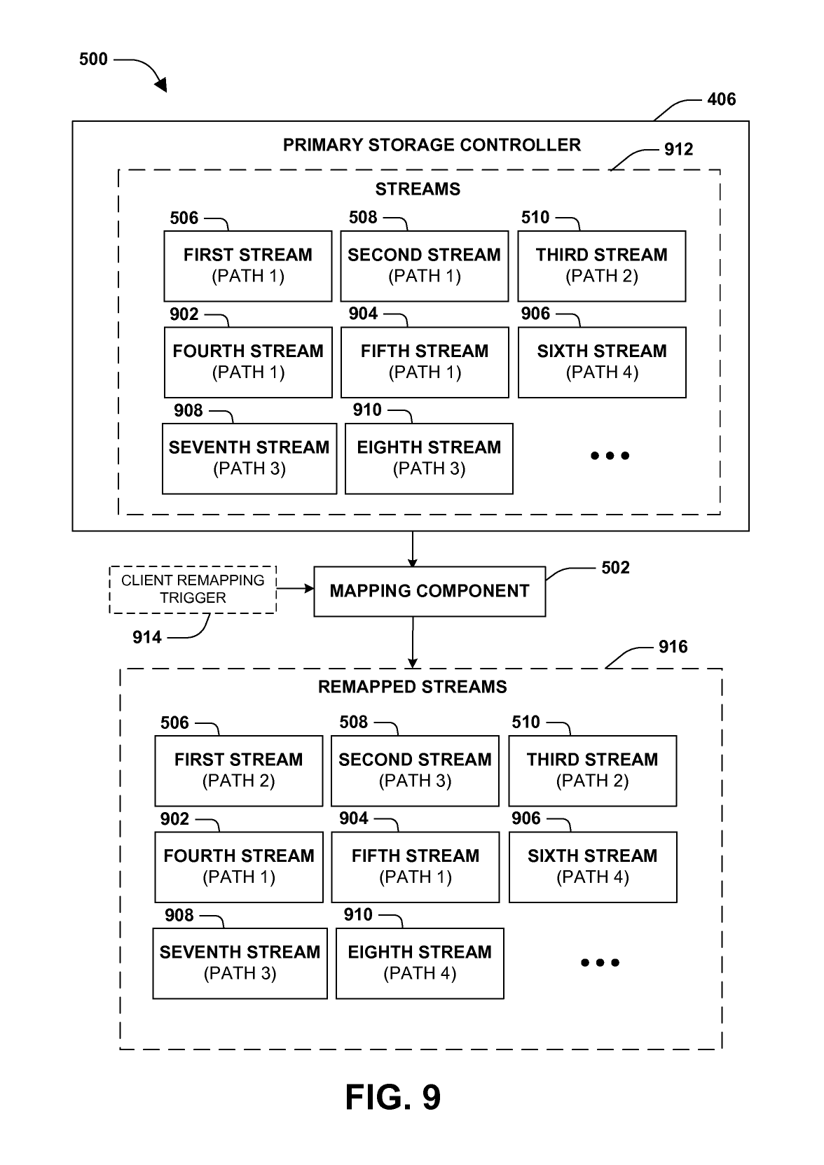

The mapping component 502 may be configured to remap (e.g., reassign) streams to interconnect paths, as illustrated in FIG. 9. In an example, a current mapping scheme for a set of streams 912 of the primary storage controller 406 may map the first stream 506 to the first interconnect path 422, the second stream 508 to the first interconnect path 422, the third stream 510 to the second interconnect path 424, a fourth stream 902 to the first interconnect path 422, a fifth stream 904 to the first interconnect path 422, a sixth stream 906 to a fourth interconnect path, a seventh stream 908 to a third interconnect path, and an eighth stream 910 to the third interconnect path. In an example, the mapping component 502 may receive a client remapping trigger 914. The client remapping trigger 914 may indicate that no I/O will be pending in the first stream 506, the second stream 508, the third stream 510, the fourth stream 902, the fifth stream 904, the sixth stream 906, the seventh stream 908, and/or the eighth stream 910.

Accordingly, the mapping component 502 may remap one or more streams within the set of streams 912 to create a set of remapped streams 916. For example, the mapping component 502 may remap the first stream 506 from the first interconnect path 422 to the second interconnect path 424, the second stream 508 from the first interconnect path 422 to the third interconnect path, and the eighth stream 910 from the third interconnect path to the fourth interconnect path based upon a load remapping criteria (e.g., indicting that a load, such as a total size of I/O mirrored across the first interconnect path 422, is above a load threshold, and thus one or more streams may be remapped from the first interconnect path 422 to a different interconnect path) and/or a stream to path remapping criteria (e.g., indicating that one or more streams are to be remapped from the first interconnect path 422 to the fourth interconnect path because the first interconnect path 422 has 4 stream to path mappings and the fourth interconnect path has 1 stream to path mapping). In this way, load balancing may be dynamically performed (e.g., based upon the client remapping trigger 914; a consistency point where the primary write cache is to be flushed to a storage device; or other remapping triggers).

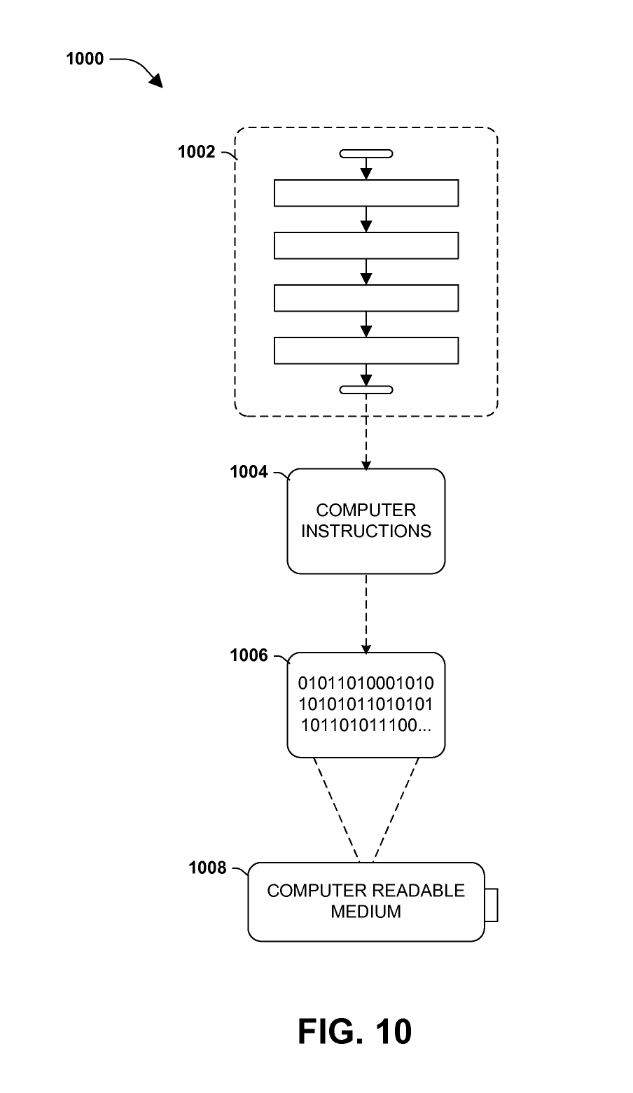

Still another embodiment involves a computer-readable medium comprising processor-executable instructions configured to implement one or more of the techniques presented herein. An example embodiment of a computer-readable medium or a computer-readable device that is devised in these ways is illustrated in FIG. 10, wherein the implementation 1000 comprises a computer-readable medium 1008, such as a CD-R, DVD-R, flash drive, a platter of a hard disk drive, etc., on which is encoded computer-readable data 1006. This computer-readable data 1006, such as binary data comprising at least one of a zero or a one, in turn comprises a set of computer instructions 1004 configured to operate according to one or more of the principles set forth herein. In some embodiments, the processor-executable computer instructions 1004 are configured to perform a method 1002, such as at least some of the exemplary method 300 of FIG. 3, for example. In some embodiments, the processor-executable instructions 1004 are configured to implement a system, such as at least some of the exemplary system 500 of FIG. 5, for example. Many such computer-readable media are contemplated to operate in accordance with the techniques presented herein.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), EEPROM and/or flash memory, CD-ROMs, CD-Rs, CD-RWs, DVDs, cassettes, magnetic tape, magnetic disk storage, optical or non-optical data storage devices and/or any other medium which can be used to store data.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, a program, or a computer. By way of illustration, both an application running on a controller and the controller can be a component. One or more components residing within a process or thread of execution and a component is localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for mirroring a caching log data structure from a primary storage controller to a secondary storage controller over multiple interconnect paths, comprising:
parsing a caching log data structure of a primary storage controller into a first stream and a second stream;
assigning the first stream to a first interconnect path between the primary storage controller and a secondary storage controller;
assigning the second stream to a second interconnect path between the primary storage controller and the secondary storage controller;
enforcing a data ordering rule during mirroring of first storage information of the first stream from a primary write cache of the primary storage controller to a secondary write cache of the secondary storage controller over the first interconnect path; and
enforcing the data ordering rule during mirroring of second storage information of the second stream from the primary write cache to the secondary write cache over the second interconnect path.

2. The method of claim 1, the caching log data structure comprising a serialized log corresponding to data cached by the primary controller within a primary write cache.

3. The method of claim 1, comprising performing the mirroring of the first storage information and the mirroring of the second storage information concurrently.

4. The method of claim 1, the first storage information comprising first data and first metadata describing the first data.

5. The method of claim 1, comprising:
not utilizing the second interconnect path in association with the first stream while the first stream is assigned to the first interconnect path.

6. The method of claim 1, comprising:
not utilizing the first interconnect path in association with the second stream while the second stream is assigned to the second interconnect path.

7. The method of claim 1, the data ordering rule specifying that data is to be sent according to a data sending order such that the secondary storage controller receives the data according to the data sending order.

8. The method of claim 1, the data ordering rule specifying that data is to be sent before metadata describing the data.

9. The method of claim 1, comprising:
parsing the caching log data structure into a third stream;
assigning the third stream to the first interconnect path; and
enforcing the data ordering rule during mirroring of third storage information of the third stream from the primary write cache to the secondary write cache over the first interconnect path.

10. The method of claim 1, comprising:
responsive to receiving a client remapping trigger from a client device, remapping at least one of the first stream or the second stream to at least one of the first interconnect path or the second interconnect path.

11. The method of claim 1, comprising:
remapping at least one of the first stream or the second stream based upon a round robin remapping scheme.

12. The method of claim 1, comprising:
remapping at least one of the first stream or the second stream based upon a dynamic remapping scheme.

13. The method of claim 12, the dynamic mapping scheme specifying a load remapping criteria.

14. The method of claim 12, the dynamic mapping scheme specifying a stream to path remapping criteria.

15. The method of claim 1, the secondary storage controller configured as a disaster recovery storage controller for the primary storage controller, the primary storage controller hosted by a first physical data site, the secondary storage controller hosted by a second physical data site.

16. A system for mirroring a caching log data structure from a primary storage controller to a secondary storage controller over multiple interconnect paths, comprising:
a mapping component configured to:
parse a caching log data structure of a primary storage controller into a first stream and a second stream;
assign the first stream to a first interconnect path between the primary storage controller and a secondary storage controller;
assign the second stream to a second interconnect path between the primary storage controller and the secondary storage controller;
enforce a data ordering rule during mirroring of first storage information of the first stream from a primary write cache of the primary storage controller to a secondary write cache of the secondary storage controller over the first interconnect path; and
enforce the data ordering rule during mirroring of second storage information of the second stream from the primary write cache to the secondary write cache over the second interconnect path.

17. The system of claim 16, the mapping component configured to:
remap at least one of the first stream or the second stream based upon at least one of a client remapping trigger, a round robin remapping scheme, or a dynamic remapping scheme, the dynamic remapping scheme specifying at least one of a load remapping criteria or a stream to path remapping criteria.

18. The system of claim 16, the first storage information mirrored concurrently with the second storage information.

19. The system of claim 16, the data ordering rule specifying at least one of that data is to be sent according to a data sending order such that the secondary storage controller receives the data according to the data sending order or that data is to be sent before metadata describing the data.

20. A computer readable medium comprising instructions that when executed perform a method for mirroring a caching log data structure from a primary storage controller to a secondary storage controller over multiple interconnect paths, comprising:
parsing a caching log data structure of a primary storage controller into a first stream and a second stream;
assigning the first stream to a first interconnect path between the primary storage controller and a secondary storage controller;
assigning the second stream to a second interconnect path between the primary storage controller and the secondary storage controller;
enforcing a data ordering rule during mirroring of first storage information of the first stream from a primary write cache of the primary storage controller to a secondary write cache of the secondary storage controller over the first interconnect path; and
enforcing the data ordering rule during mirroring of second storage information of the second stream from the primary write cache to the secondary write cache over the second interconnect path.
